(19) United States
(12) Patent Application Publication
(10) Pub. No.: US 2017/0292491 A1
(43) Pub. Date: Oct. 12, 2017

(54) IGNITION SYSTEM FOR A COMBUSTION CHAMBER OF A TURBOSHAFT ENGINE

(71) Applicant: SAFRAN HELICOPTER ENGINES, Bordes (FR)

(72) Inventors: Romain THIRIET, Jurancon (FR); Jean-Michel BAZET, Gelos (FR); Guillaume COTTIN, Pau (FR); Camel SERGHINE, Boeil-Bezing (FR); Patrick MARCONI, Gelos (FR); Bertrand MOINE, Gan (FR); Vincent POUMAREDE, Tarbes (FR)

(73) Assignee: SAFRAN HELICOPTER ENGINES, Bordes (FR)

(21) Appl. No.: 15/518,199

(22) PCT Filed: Oct. 6, 2015
(86) PCT No.: PCT/FR2015/052682

§ 371 Date: Apr. 10, 2017

(30) Foreign Application Priority Data
Oct. 13, 2014 (FR) 1459811

(51) Int. Cl. F02P 7/02; F02C 9/26; F02P 5/04

(52) U.S. Cl. CPC F02P 7/028; F02P 5/045; F02C 9/266; F02C 9/56

(57) ABSTRACT

A system for igniting a combustion chamber of a turboshaft engine, comprising: a plurality of start-up injectors which are suitable for injecting fuel into said chamber during a combustion-initiating phase; a circuit for supplying fuel to said start-up injectors, comprising a first sub-circuit, referred to as the primary start-up circuit, designed to supply fuel to some of said plurality of start-up injectors; a second sub-circuit, referred to as the secondary start-up circuit, designed to supply fuel to the other start-up injectors of said plurality.

### 1. TECHNICAL FIELD OF THE INVENTION

The invention relates to a system for igniting a combustion chamber of a turboshaft engine. The invention relates in particular to a system for igniting a combustion chamber of a turboshaft engine which is capable of being put into a standby mode and of being quickly reactivated if needed.

### 2. TECHNOLOGICAL BACKGROUND

As is known, a twin-engine or three-engine helicopter has a propulsion system comprising two or three turboshaft engines, each turboshaft engine comprising a gas generator and a free turbine which is rotated by the gas generator and is rigidly connected to an output shaft. The output shaft of each free turbine is suitable for inducing the movement of a power transmission unit, which itself drives the rotor of the helicopter. The gas generator comprises a combustion chamber into which injectors for fuel supplied by a supply circuit lead.

It is known that, when the helicopter is in a cruise flight situation (i.e. when it is progressing in normal conditions, during all flight phases apart from transitional phases of take-off, ascent, landing or hovering flight), the turboshaft engines develop low power levels, below their maximum continuous output. These low power levels give rise to a specific consumption (hereinafter SC), defined as the ratio between the hourly consumption of fuel by the combustion chamber of the turboshaft engine and the mechanical power supplied by this turboshaft engine, of greater than approximately 30% of the SC of the maximum take-off power, and they therefore give rise to overconsumption of fuel in cruising flight.

Furthermore, the turboshaft engines of a helicopter are designed so as to be oversized in order to be able to keep the helicopter in flight in the event of failure of one of the engines. This flight situation occurs following the loss of an engine and results in each operating engine supplying a power level much beyond its nominal power to allow the helicopter to deal with a hazardous situation, and then to be able to continue its flight.

The turboshaft engines are also oversized so as to be able to ensure flight over the entire flight range specified by the aircraft manufacturer, and in particular flight at high altitudes and during hot weather. These flight points, which are highly demanding, in particular when the helicopter has a weight close to its maximum take-off weight, are encountered only in certain circumstances of use.

These oversized turboshaft engines are disadvantageous in terms of weight and fuel consumption. In order to reduce this consumption in cruising flight, it is envisaged to put at least one of the turboshaft engines on standby in flight. The active engine or engines then operate at higher power levels in order to provide all the necessary power, and therefore at more favourable SC levels.

Putting a turboshaft engine on standby requires the provision of a rapid reactivation system which makes it possible to quickly take the turboshaft engine out of the standby state if needed. This need may arise, for example, when one of the active engines fails or if the flight conditions deteriorate unexpectedly, meaning that the total power is required once again.

The applicant has therefore sought to optimise the system for igniting a combustion chamber of a turboshaft engine so as to be able in particular to quickly reactivate the turboshaft engine when it is on standby and when the flight conditions mean that the total available power is required once again.

As is known, a system for igniting a combustion chamber of a turboshaft engine of a helicopter comprises start-up injectors intended for initiating combustion and main injectors intended for maintaining the combustion once it has been initiated. It is known that main injectors are supplied with fuel by a main circuit and the start-up injectors are supplied with fuel by a start-up circuit, which is separate from the main circuit. A known ignition system makes it possible to initiate combustion by means of start-up injectors associated with at least one start-up spark plug suitable for providing the spark for setting alight the mixture of air and fuel in the combustion chamber. The flame then spreads from the start-up injectors towards the main injectors.

When designing an ignition system for a turboshaft engine, engineers have to choose between using a large number of start-up injectors, which allows the flame to spread rapidly towards the main injectors but means that it takes longer for the fuel to be conveyed to all of the injectors, and using a small number of start-up injectors, which allows fuel to be conveyed to the start-up injectors more quickly but means that it takes longer for the flame to spread towards the main injectors.

The inventors have therefore sought to propose a solution which makes it possible for the flame to spread rapidly from the start-up injectors towards the main injectors, while at the same time allowing the start-up injectors to be quickly filled with fuel.

In other words, the inventors have sought to reconcile the two alternatives which are, in principle, incompatible.

The inventors have also sought to provide an ignition system having improved reliability compared with known systems, in order to improve the safety of helicopters provided with hybrid turboshaft engines capable of being put into standby mode.

### 3. AIMS OF THE INVENTION

The invention aims to provide a system for igniting a combustion chamber of a turboshaft engine and makes it possible to quickly ignite the combustion chamber, while allowing the turboshaft engine to be reactivated quickly.

The invention also aims to provide an ignition system which combines the advantages of the flame spreading rapidly from the start-up injectors towards the main injectors and of the start-up injectors being filled up quickly.

The invention also aims to provide an ignition system which has improved reliability by comparison with systems from the prior art.

The invention also aims to provide a turboshaft engine provided with an ignition system according to the invention.

### 4. DISCLOSURE OF THE INVENTION

In order to achieve this, the invention relates to a system for igniting a combustion chamber of an aircraft turboshaft engine, comprising:
a plurality of start-up injectors which lead into said combustion chamber and are suitable for injecting fuel into said chamber during a combustion-initiating phase,
a circuit for supplying fuel to said start-up injectors, referred to as the start-up circuit,
a plurality of main injectors which lead into said combustion chamber and are suitable for injecting fuel into said combustion chamber so as to maintain the combustion once said combustion has been initiated by said start-up injectors.

The ignition system according to the invention is characterised in that the start-up circuit comprises:
a first sub-circuit, referred to as the primary start-up circuit, designed to supply fuel to some of said plurality of start-up injectors, referred to as the primary start-up injectors,
a second sub-circuit, referred to as the secondary start-up circuit, designed to supply fuel to the other start-up injectors of said plurality, referred to as the secondary start-up injectors.

The ignition system is also characterised in that said primary start-up circuit and said secondary start-up circuit each comprise a solenoid start-up valve suitable for being controlled by a control unit so as to allow or prevent the supply of fuel to said primary and secondary start-up injectors, respectively.

An ignition system according to the invention therefore comprises two separate start-up circuits, namely one primary circuit intended for supplying fuel to primary start-up injectors and one secondary circuit intended for supplying fuel to secondary start-up injectors. Furthermore, each circuit is provided with a solenoid valve controlled by a control unit for allowing or preventing the supply of fuel to the injectors. An ignition system according to the invention may therefore comprise a large number of start-up injectors, and yet without having the disadvantage of it taking a long time to fill up the injectors, since said injectors are distributed across two separate supply circuits.

Furthermore, an ignition system according to the invention is more reliable than the systems from the prior art as a result of being provided with two separate start-up circuits. Moreover, if a solenoid valve of one of the start-up circuits fails, the other circuit can take over and ensure that the turboshaft engine is reactivated. An ignition system of this kind is therefore particularly suitable for hybrid turboshaft engines capable of being put into a standby mode during flight, on account of having improved reliability which makes it possible to guarantee that the turboshaft engine is reactivated if needed.

Advantageously and according to the invention, the solenoid valves are controlled by the control unit using a sequential or simultaneous procedure, the procedure being selected according to the flight conditions of said aircraft.

The flight conditions of the aircraft, for example a helicopter, include for example the ambient temperature, ambient pressure, rotational speed of the gas generator of the turboshaft engine, etc. These different parameters are used by the control unit to define which procedure is the best to implement in order to start up the turboshaft engine, taking account of the flight conditions, from either a simultaneous start-up procedure for the two start-up circuits or a sequential start-up procedure for the two circuits.

Advantageously and according to the invention, said solenoid valves are controlled by the control unit such that, on the ground, each start-up circuit is used alternately for each flight so as to limit dormancy of a possible failure to a single flight.

According to this advantageous variant, the ignition system is designed such that, on the ground, the turbine is started alternately for each flight in a single start-up circuit. This makes it possible to limit the dormancy of a possible failure to a single flight.

Advantageously and according to the invention, each start-up injector is associated with a rail for supplying fuel to said injector, said supply rail of a primary start-up injector having a lower volume than said supply rail of a secondary start-up injector so as to be able to be filled up with fuel more quickly.

According to this advantageous variant, the primary and secondary circuits are different from one another. The primary circuit has injectors having a filling rail of a reduced volume by comparison with the secondary injectors. Therefore, the primary injectors can be quickly filled up with fuel and can quickly initiate combustion in the combustion chamber. The secondary injectors continue the combustion and can, in combination with the primary injectors, ensure that the flame spreads towards the main injectors once the combustion has been initiated.

Advantageously, an ignition system according to the invention comprises one spark plug opposite each start-up injector, which spark plug is suitable for providing a spark for setting alight the fuel in said combustion chamber.

A spark plug being opposite each start-up injector, i.e. both primary and secondary start-up injectors, makes it possible to speed up the combustion and the spreading of the flame towards the main injectors.

Advantageously, an ignition system according to the invention comprises two primary start-up injectors and two secondary start-up injectors.

An ignition system according to the invention, according to one or the other advantageous variants described, is particularly intended for being fitted in a hybrid turboshaft engine capable of being put into a standby mode, so as to be able to reactivate said engine if needed.

When the helicopter is on the ground, the primary and secondary start-up circuits are tested independently of one another so as to check the integrity thereof and allow the hybrid turboshaft engine to be put on standby during flight.

When the helicopter is in cruise flight, the hybrid turboshaft engine can therefore be put on standby.

An ignition system according to the invention can also be designed such that, on the ground, the turbine is started alternately for each flight in a single start-up circuit. This makes it possible to limit dormancy of a possible failure to a single flight.

If the flight conditions require the turboshaft engine to be reactivated in the normal manner, for example because the helicopter is going to transition from a cruise flight phase to a landing phase, the ignition system according to the invention is used by controlling the two start-up circuits, namely the primary start-up circuit and the secondary start-up circuit, and the different power supply paths of the spark plugs. The primary and secondary circuits can be controlled simultaneously or sequentially. Normal reactivation of the hybrid turboshaft engine is reactivation which occurs 10 seconds to 1 minute, in particular 30 seconds to 1 minute, after the reactivation command.

If the flight conditions require the turboshaft engine to be reactivated quickly, for example because one of the active turboshaft engines suddenly fails, the ignition system according to the invention is used by consecutively controlling the primary start-up circuit and then the secondary start-up circuit once it has been detected that the chamber is ignited. According to another variant, the primary and secondary circuits are controlled simultaneously.

The invention also relates to a turboshaft engine comprising a combustion chamber, characterised in that said engine comprises an ignition system according to the invention.

The invention also relates to an aircraft, in particular a helicopter, comprising at least one turboshaft engine according to the invention.

The invention also relates to an ignition system, to a turboshaft engine and to an aircraft, characterised in combination by all or some of the features mentioned above or below.

### 5. LIST OF FIGURES

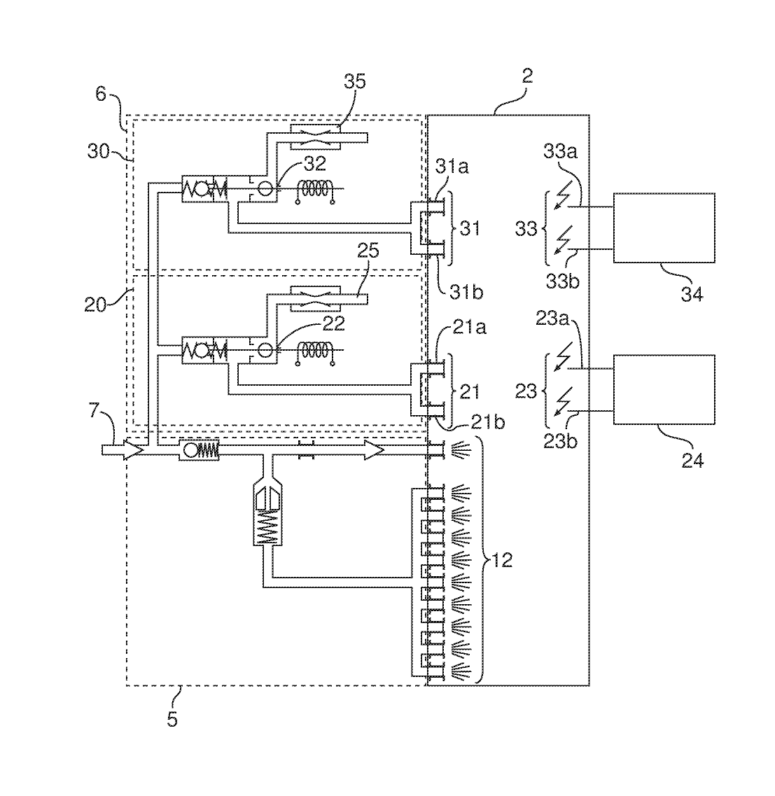

Other aims, features and advantages of the invention will emerge from reading the following description, which is given purely by way of non-limiting example and relates to the accompanying FIG. 1, which is a schematic view of an ignition system according to an embodiment of the invention.

### 6. DETAILED DESCRIPTION OF AN EMBODIMENT OF THE INVENTION

In the figure, the scales and proportions are not respected for the sake of illustration and clarity.

FIG. 1 is a schematic view of a system for igniting a combustion chamber 2 of a turboshaft engine.

The system comprises start-up injectors 21a, 21b, 31a, 31b which lead into the combustion chamber 2 and are suitable for injecting fuel into the chamber 2 during a combustion-initiating phase.

The system also comprises main injectors 12 which lead into the combustion chamber 2 and are suitable for injecting fuel into the chamber 2 at a higher flow rate once combustion has been initiated.

The combustion chamber 2 is shown schematically by a rectangle in FIG. 1 for the sake of clarity. In practice, the combustion chamber generally comprises two annular walls, namely an outer wall and an inner wall, which extend one inside the other and are connected by an annular bottom wall of the chamber. The fuel injectors are distributed over the entire circumference of the combustion chamber.

The system also comprises a circuit for supplying fuel to the main injectors 12, referred to as the main circuit 5, and a circuit for supplying fuel to the start-up injectors 21, 31, referred to as the start-up circuit 6.

These two circuits are connected to a fuel inlet 7 which is supplied with fuel by a pump designed to withdraw fuel from a fuel reservoir (not shown in FIG. 1).

According to the invention, the start-up circuit 6 for supplying fuel to the start-up injectors 21, 31 is formed of two sub-circuits, namely a first sub-circuit, referred to as the primary start-up circuit 20, which is designed to supply fuel to the injectors 21, referred to as the primary start-up injectors, and a second sub-circuit, referred to as the secondary start-up circuit 30, which is designed to supply fuel to the start-up injectors 31, referred to as the secondary start-up injectors.

The primary start-up circuit 20 also comprises a solenoid valve 22 controlled for example by the engine electronic control unit (better known by the acronym EECU) of the helicopter. The secondary start-up circuit 30 also comprises a solenoid valve 32 controlled by the EECU. The solenoid valve 22 is designed to allow or prevent the supply of fuel to the primary start-up injectors 21. The solenoid valve 32 is designed to allow or prevent the supply of fuel to the primary start-up injectors 31.

The primary start-up injectors 21 have fuel supply rails that have a volume that is smaller than the volume of the rails for supplying fuel to the secondary start-up injectors 31. This means that, when the solenoid valves are open, the primary injectors 21 are quickly activated and initiate combustion in the combustion chamber 2. The secondary injectors 31 continue the combustion once the corresponding rails are filled, and this process takes slightly longer for said secondary injectors than for the primary injectors owing to said secondary injectors having a larger volume.

Once the start-up injectors 21, 31 are active, the combustion in the combustion chamber is maintained by the activation of the injectors 12 of the main circuit combined with the spreading of the flame from the start-up injectors 31, 21 to the main injectors 12. Once the main injectors 12 have taken over from the start-up injectors 21, 31, the primary and secondary start-up circuits are bled and the fuel residue is discharged to a collector via channels 25, 35. Bleeding the start-up injectors after they have stopped supplying fuel makes it possible to avoid coking (carbonisation of the fuel in the pipes) and therefore prevents the injectors from becoming clogged.

According to the embodiment of FIG. 1, each start-up injector 21a, 21b, 31a, 31b is associated with a spark plug 23a, 23b, 33a, 33b arranged opposite the injector. Each spark plug 23a, 23b, 33a, 33b is supplied with electricity from an electrical circuit 24, 34 comprising a high-voltage electrical power source. Each spark plug is designed to produce a spark that sets alight the mixture of air and fuel in the combustion chamber 2.

There being one spark plug per start-up injector makes it possible to reduce the time taken for the flame to spread towards the main injectors, and therefore to ultimately reduce the start-up time of the turboshaft engine provided with an ignition system of this kind.

The invention is not limited to the described embodiment. In particular, according to other embodiments, the ignition system may comprise more than four start-up injectors and/or a different number of primary start-up injectors and secondary start-up injectors.

1. System for igniting a combustion chamber of an aircraft turboshaft engine, comprising:
a plurality of start-up injectors which lead into said combustion chamber and are configured to inject fuel into said chamber during a combustion-initiating phase;
a start-up circuit configured to supply fuel to said start-up injectors; and
a plurality of main injectors which lead into said combustion chamber and are configured to inject fuel into said combustion chamber so as to maintain the combustion once said combustion has been initiated by said start-up injectors; wherein said start-up circuit comprises:
a first primary sub-circuit, configured to supply fuel to a subset of said plurality of start-up injectors;
a secondary sub-circuit, configured to supply fuel to the remaining start-up injectors of said plurality of start-up injectors;
and wherein said primary sub-circuit and said secondary sub-circuit each comprise a solenoid start-up valve configured to be controlled by a control unit so as to allow or prevent the supply of fuel to said start-up injectors.

2. System according to claim 1, wherein said solenoid valves are controlled by said control unit using a sequential or simultaneous procedure, the procedure being selected according to the flight conditions of said aircraft.

3. System according to claim 1, wherein said solenoid valves are controlled by said control unit such that, on the ground, each sub-circuit is used alternately for each flight so as to limit dormancy of a possible failure to a single flight.

4. System according to claim 1, wherein each start-up injector is associated with a rail for supplying fuel to said injector, said supply rail of one start-up injector of the subset of start-up injectors having a lower volume than said supply rail of a start-up injector of the remaining start-up injectors so as to be able to be filled up with fuel more quickly.

5. System according to claim 1, further comprising one spark plug opposite each start-up injector, which spark plug is configured to supply a spark for setting alight the fuel in said combustion chamber.

6. System according to claim 1, wherein the subset of said plurality of start-up injectors comprises two start-up injectors and wherein the remaining start-up injectors comprise two start-up injectors.

7. Turboshaft engine comprising a combustion chamber, wherein said engine comprises a system for igniting said combustion chamber according to claim 1.

8. An aircraft, comprising:
at least one turboshaft engine, the at least one turboshaft engine including:
a plurality of start-up injectors which lead into said combustion chamber and are configured to inject fuel into said chamber during a combustion-initiating phase;
a start-up circuit configured to supply fuel to said start-up injectors; and
a plurality of main injectors which lead into said combustion chamber and are configured to inject fuel into said combustion chamber so as to maintain the combustion once said combustion has been initiated by said start-up injectors;
wherein said start-up circuit comprises:
(i) a primary sub-circuit, configured to supply fuel to a subset of said plurality of start-up injectors;
(ii) a secondary sub-circuit, configured to supply fuel to the remaining start-up injectors of said plurality of start-up injectors;
wherein said primary sub-circuit and said secondary sub-circuit each comprise a start-up valve configured to be controlled by a control unit so as to allow or prevent the supply of fuel to said start-up injectors.

9. The aircraft according to claim 8, wherein said start-up valves are controlled by said control unit using a sequential or simultaneous procedure, the procedure being selected according to the flight conditions of said aircraft.

10. The aircraft according to claim 8, wherein said start-up valves are controlled by said control unit such that, on the ground, each sub-circuit is used alternately for each flight so as to limit dormancy of a possible failure to a single flight.

11. The aircraft according to claim 8, wherein each start-up injector is associated with a rail for supplying fuel to said injector, said supply rail of one start-up injector of the subset of start-up injectors having a lower volume than said supply rail of a start-up injector of the remaining start-up injectors so as to be able to be filled up with fuel more quickly.

12. The aircraft according to claim 8, further comprising one spark plug opposite each start-up injector, which spark plug is configured to supply a spark for setting alight the fuel in said combustion chamber.

13. The aircraft according to claim 8, wherein the subset of said plurality of start-up injectors comprises two start-up injectors and wherein the remaining start-up injectors comprise two start-up injectors.
